(19) United States
(12) Patent Application Publication
(10) Pub. No.: US 2026/0072904 A1
(43) Pub. Date: Mar. 12, 2026

(54) SYSTEM AND METHOD FOR DYNAMIC DOMAIN KNOWLEDGE AND INSTRUCTION RETRIEVAL-AUGMENTED GENERATION

(71) Applicant: Wix.com Ltd., Tel Aviv (IL)

(72) Inventors: Yuval AVIYAM, Rishon Lezion (IL); Yaniv BEN SIMON, Ramat Gan (IL); Ran GELER, Petach Tikva (IL); Kfir BLOCH, Tel Aviv (IL); Yoav ABRAHAMI, Tel Aviv (IL)

(21) Appl. No.: 19/325,682

(22) Filed: Sep. 11, 2025

Related U.S. Application Data
(60) Provisional application No. 63/693,258, filed on Sep. 11, 2024.

(51) Int. Cl. G06F 16/242; G06F 16/2452; G06F 16/28; G06N 5/01

(52) U.S. Cl. CPC G06F 16/243; G06F 16/2452; G06F 16/285; G06N 5/01

(57) ABSTRACT

A system for dynamically adapting a conversational artificial intelligence (AI) system includes a chatbot system, a feedback and classifier unit, and a document generator. The chatbot system generates a response to a user query. The feedback and classifier unit receives the user query, a large language model (LLM) provided response, and system architect provided feedback to create a data object. The unit retrieves a set of ternary questions from a questions database and processes the data object using the LLM to generate answers, creating a feature vector of ternary answers. It then determines a classification label for the feedback by processing the feature vector with a decision tree, where the label indicates a knowledge or behavioral update. The document generator creates a new document based on the classification label and feedback and updates a knowledge base or prompts database with the new document based on the determined classification label.

### CROSS REFERENCE TO RELATED APPLICATIONS

This application claims priority from U.S. provisional patent application 63/693,258, filed Sep. 11, 2024, which is incorporated herein by reference.

### FIELD OF THE INVENTION

The present invention relates generally to conversational artificial intelligence systems and to feedback-driven adaptation of their knowledge bases in particular.

### BACKGROUND OF THE INVENTION

Artificial Intelligence (AI) chatbots have become increasingly prevalent in various sectors, including customer service, technical support, and business operations. These chatbots are designed to simulate human conversation and respond to user queries. They are typically powered by Large Language Models (LLMs), which are pre-trained on diverse text data, enabling them to excel at understanding context and generating text.

To improve the accuracy of LLMs for a specific domain, artificial intelligence (AI) builders often apply techniques to increase the awareness of LLMs to their domain. One common technique is Retrieval-Augmented Generation (RAG), which provides better context for the LLM by retrieving relevant documents from a knowledge base to inform the LLM's responses.

Retrieval-augmented generation (RAG) is a technique that combines the retrieval of relevant documents from a database with the generative capabilities of a language model to produce responses that are informed by existing knowledge. In conventional RAG systems, a knowledge database stores information and documents. An embedding model connects to the knowledge database and processes the stored information to create vector representations. These vector representations are then stored in a vector database.

A typical RAG system operates by receiving a query, which is then embedded into a vector representation. The embedded query is compared with all vectors in a document database, and the top-scoring documents are retrieved. The query and top-scoring documents are then input into the LLM along with relevant prompts to generate a response.

Reference is now made to FIG. 1, which illustrates a system 15 for a chatbot system (bot) 2 from the point of view of an end-user 1. End user 1 may interact with bot 2 by submitting a query to the bot and receiving an answer. Bot 2 may process the query and may utilize a prompt selector to formulate a prompt using a prompt template from a prompts database 4 which is then sent to an LLM 5. The system also includes a RAG knowledge base 5 from which information is retrieved and provided as context to LLM 5 along with the generated prompt. LLM 5 generates a response based on the combined information, which is then delivered to the end user. It will be appreciated that end-user 1 may be a human or may be an Artificial Intelligence (AI) agent acting on behalf of the real user. Such systems may be implemented within larger platforms, such as a Website Building System (WBS), to assist users with various tasks.

### SUMMARY OF THE PRESENT INVENTION

There is therefore provided, in accordance with a preferred embodiment of the present invention, a system for dynamically adapting a conversational artificial intelligence (AI) system, the system including at least one processor, and a memory storing instructions that, when executed by the at least one processor, configure the system to include a chatbot system, a feedback and classifier unit, and a document generator. The chatbot system is configured to generate a response to a user query. The feedback and classifier unit is configured to receive the user query, an LLM provided response to the query, and system architect provided feedback associated with the response and to create a data object accordingly, retrieve a set of ternary questions from a questions database, process, using the LLM, the data object to generate answers to the set of predefined ternary questions, thereby creating a feature vector of ternary answers, and determine, using a decision tree, a classification label for the feedback by processing the feature vector, where the classification label indicates whether the feedback relates to a knowledge update or a behavioral instruction update. The document generator is configured to create a new document based on the classification label and the feedback, where the document generator updates one of a knowledge base or a prompts database with the new document based on the determined classification label.

Moreover, in accordance with a preferred embodiment of the present invention, the chatbot system includes a query processor and retriever, a prompt assembler, a response formatter, and a logger. The query processor and retriever converts the user query into a vector representation and retrieves relevant documents from the knowledge base and the prompts database based on vector similarity. The prompt assembler constructs a comprehensive prompt by combining the user query with retrieved knowledge documents and retrieved prompt instruction documents. The response formatter processes raw output from a large language model into a user-friendly format. The logger stores user queries and associated responses.

Further, in accordance with a preferred embodiment of the present invention, the feedback and classifier unit includes a query, response, and feedback (QRF) processor, an LLM question processor, a decision tree classifier, and a knowledge document generator or a prompt instruction document. The QRF processor is configured to consolidate the user query, the LLM provided response, and the feedback into a structured data package. The LLM question processor is configured to apply the set of predefined ternary questions to the structured data package using the first machine learning model to generate the feature vector. The decision tree classifier is configured to traverse a tree structure following a branch corresponding to an answer in the feature vector, where a label of the leaf node represents the classification label. The knowledge document generator is configured to add to or correct contextual information stored in the knowledge base, or the prompt instruction document is configured to modify a behavioral instruction stored in the prompts database.

Still further, in accordance with a preferred embodiment of the present invention, the LLM question processor is configured to receive answers of yes, no, or do not know for each of the predefined ternary questions.

Additionally, in accordance with a preferred embodiment of the present invention, the decision tree is a gradient boosting algorithm trained on feature vectors paired with classification labels.

Moreover, in accordance with a preferred embodiment of the present invention, the classification label is selected from a group consisting of enrichment, escalate, mute, technical issue, navigate, tone style, insufficient data, and nothing.

Further, in accordance with a preferred embodiment of the present invention, when the classification label indicates enrichment, the document generator creates a knowledge document including a content field, a document type marked as knowledge, metadata, and a vector embedding for insertion into the knowledge base.

Still further, in accordance with a preferred embodiment of the present invention, when the classification label indicates a behavioral instruction, the document generator creates a prompt instruction document including an instruction type, a template integration point, instruction content, a priority level, and conditional logic for insertion into the prompts database.

Additionally, in accordance with a preferred embodiment of the present invention, the system further includes a CFQ editor configured to enable a system architect to provide the feedback and to define the set of predefined ternary questions and to create training data for the decision tree by providing representative examples of feedback paired with ground truth classification labels.

Moreover, in accordance with a preferred embodiment of the present invention, the system is implemented within a host platform, the host platform being a Website Building System (WBS), where the user is one of a human end-user, first AI agent and a website or e-shop owner or operator, and where the system architect provided feedback is received from one of a human system architect or a second AI agent configured to provide the feedback automatically.

Further, in accordance with a preferred embodiment of the present invention, the document generator is further configured to assign a priority weight to knowledge documents generated from feedback intended to correct factual errors, where the priority weight causes the query processor and retriever to prioritize corrected information during vector similarity searches over contradictory information in the knowledge base.

Still further, in accordance with a preferred embodiment of the present invention, the query processor and retriever implements a hybrid ranking system that combines textual scoring and semantic scoring to determine document relevance, where when multiple documents receive equal relevance scores, all equally scored documents are provided to the large language model.

Additionally, in accordance with a preferred embodiment of the present invention, the classification label is determined using a gradient boosting algorithm trained on feature vectors including ternary answers, and where the gradient boosting algorithm includes a classifier optimized for categorical features.

Moreover, in accordance with a preferred embodiment of the present invention, the document generator is further configured to create a flow control document when the classification label indicates conversation management requirements, where the flow control document is retrieved by the query processor and retriever but intercepted before reaching the prompt assembler to redirect or terminate a standard processing pipeline.

Further, in accordance with a preferred embodiment of the present invention, the feedback and classifier unit is further configured to perform a contradiction detection process including initiating a semantic similarity search to identify existing documents with high cosine similarity to a new document being generated, comparing substantive content between the existing documents and the new document, flagging conflicts when the new document contains information factually inconsistent with the existing documents, and transmitting a warning notification requiring manual resolution of detected contradictions.

Still further, in accordance with a preferred embodiment of the present invention, the Website Building System supports multiple user levels including system architects and end-users, where system architects at higher levels create and manage chat-based assistants for users at lower levels, and where the system supports multi-tenant architecture with authoring environments for creating blogs, blog posts, and user interactions.

Additionally, in accordance with a preferred embodiment of the present invention, the set of predefined ternary questions are generated through an iterative process including generating initial questions using a large language model provided with all available classification categories, manually refining the questions by adding differentiating questions and removing non-separating questions, testing questions on sample inputs to evaluate classification effectiveness, and iteratively modifying the question set based on test results.

Moreover, in accordance with a preferred embodiment of the present invention, the prompt assembler implements template-based prompt modification using predefined variable slots, where prompt instruction documents specify variable replacement content for dynamic behavioral adaptation.

There is therefore provided, in accordance with a preferred embodiment of the present invention, a computer-implemented method for dynamically adapting a conversational artificial intelligence system. The method includes receiving a user query, an AI-generated response to the user query, and feedback associated with the AI-generated response, retrieving a set of predefined ternary questions from a questions database, processing, using the LLM, the user query, the AI-generated response, and the feedback to generate answers to the set of predefined ternary questions, thereby creating a feature vector of ternary answers, determining, using a decision tree, a classification label for the feedback by processing the feature vector, where the classification label indicates whether the feedback relates to a knowledge update or a behavioral instruction update, generating a new document based on the classification label and the feedback, and updating one of a knowledge base or a prompts database with the new document based on the determined classification label.

Moreover, in accordance with a preferred embodiment of the present invention, the method further includes consolidating the user query, the AI-generated response, and the feedback into a structured data package prior to the processing.

Further, in accordance with a preferred embodiment of the present invention, the processing to generate answers to the set of predefined ternary questions generates answers selected from yes, no, and do not know.

Still further, in accordance with a preferred embodiment of the present invention, the decision tree is a gradient boosting algorithm trained on feature vectors paired with classification labels.

Additionally, in accordance with a preferred embodiment of the present invention, the classification label is selected from a group consisting of enrichment, escalate, mute, technical issue, navigate, tone style, insufficient data, and nothing.

Moreover, in accordance with a preferred embodiment of the present invention, when the classification label indicates enrichment, the generating a new document includes creating a knowledge document including a content field, a document type marked as knowledge, metadata, and a vector embedding for insertion into the knowledge base.

Further, in accordance with a preferred embodiment of the present invention, when the classification label indicates a behavioral instruction, the generating a new document includes creating a prompt instruction document including an instruction type, a template integration point, instruction content, a priority level, and conditional logic for insertion into the prompts database.

Still further, in accordance with a preferred embodiment of the present invention, the method further includes converting the user query into a vector representation and retrieving relevant documents from the knowledge base and the prompts database based on vector similarity.

Additionally, in accordance with a preferred embodiment of the present invention, the method further includes constructing a comprehensive prompt by combining the user query with retrieved knowledge documents and retrieved prompt instruction documents.

Moreover, in accordance with a preferred embodiment of the present invention, the receiving feedback includes receiving feedback from one of a human system architect or an AI agent configured to provide the feedback automatically.

Moreover, in accordance with a preferred embodiment of the present invention, the method further includes assigning a priority weight to knowledge documents generated from feedback intended to correct a factual error, where the priority weight is used to prioritize corrected information during vector similarity searches over contradictory information in the knowledge base.

Further, in accordance with a preferred embodiment of the present invention, the method includes retrieving relevant documents by determining document relevance using a hybrid ranking system that combines textual scoring and semantic scoring and providing all equally scored documents to a large language model when multiple documents receive equal relevance scores.

Still further, in accordance with a preferred embodiment of the present invention, the method includes determining the classification label using a gradient boosting algorithm trained on the feature vectors, and where the gradient boosting algorithm includes a classifier optimized for categorical features.

Additionally, in accordance with a preferred embodiment of the present invention, the method further includes creating a flow control document when the classification label indicates a conversation management requirement, retrieving the flow control document, and intercepting the retrieved flow control document to redirect or terminate a standard processing pipeline.

Moreover, in accordance with a preferred embodiment of the present invention, the method further includes performing a contradiction detection process, the process including initiating a semantic similarity search to identify existing documents with high cosine similarity to a new document being generated, comparing substantive content between the existing documents and the new document, flagging conflicts when the new document contains information factually inconsistent with the existing documents, and transmitting a warning notification requiring manual resolution of detected contradictions.

Further, in accordance with a preferred embodiment of the present invention, the method is implemented within a Website Building System supporting multiple user levels including system architects and end-users, the method further including enabling system architects at higher levels to create and manage chat-based assistants for users at lower levels within a multi-tenant architecture.

Still further, in accordance with a preferred embodiment of the present invention, the method further includes generating the set of predefined ternary questions through an iterative process, the process including generating initial questions using a large language model provided with all available classification categories, manually refining the questions by adding differentiating questions and removing non-separating questions, testing the questions on sample inputs to evaluate classification effectiveness, and iteratively modifying the question set based on test results.

Additionally, in accordance with a preferred embodiment of the present invention, the method includes constructing a comprehensive prompt by performing template-based prompt modification using predefined variable slots, where the retrieved prompt instruction documents specify variable replacement content for dynamic behavioral adaptation.

There is therefore provided, in accordance with a preferred embodiment of the present invention, a computer-implemented method for classifying feedback associated with a conversational artificial intelligence (AI) system. The method includes receiving, by at least one processor, a data object including a user query, an AI-generated response to the user query, and feedback associated with the AI-generated response, retrieving, from a questions database, a set of predefined ternary questions, processing, using a large language model (LLM), the received data object in view of each of the predefined ternary questions to generate a corresponding ternary answer for each question, creating a feature vector including the generated ternary answers, and determining, using the LLM, a classification label for the feedback by processing the feature vector.

Moreover, in accordance with a preferred embodiment of the present invention, the generated ternary answers are selected from a group consisting of yes, no, and do not know.

Further, in accordance with a preferred embodiment of the present invention, the classification label is selected from a group consisting of enrichment, escalate, mute, technical issue, navigate, tone style, insufficient data, and nothing.

Still further, in accordance with a preferred embodiment of the present invention, the method further includes consolidating the user query, the AI-generated response, and the feedback into a structured data package, where the processing uses the structured data package as the data object.

Additionally, in accordance with a preferred embodiment of the present invention, the method further includes creating the set of predefined ternary questions by generating differentiating questions for each of a plurality of classification categories.

There is therefore provided, in accordance with a preferred embodiment of the present invention, a system for classifying feedback associated with a conversational artificial intelligence (AI) system, the system including at least one processor, and a memory storing instructions that, when executed by the at least one processor, configure the system to include a feedback and classifier unit. The feedback and classifier unit is configured to receive a data object including a user query, an AI-generated response to the user query, and feedback associated with the AI-generated response, retrieve, from a questions database, a set of predefined ternary questions, process, using a large language model (LLM), the received data object in view of each of the predefined ternary questions to generate a corresponding ternary answer for each question, create a feature vector including the generated ternary answers, and determine, using the LLM, a classification label for the feedback by processing the feature vector.

Moreover, in accordance with a preferred embodiment of the present invention, the generated ternary answers are selected from a group consisting of yes, no, and do not know.

Further, in accordance with a preferred embodiment of the present invention, the classification label is selected from a group consisting of enrichment, escalate, mute, technical issue, navigate, tone style, insufficient data, and nothing.

Still further, in accordance with a preferred embodiment of the present invention, the feedback and classifier unit includes a query, response, and feedback (QRF) processor configured to consolidate the user query, the AI-generated response, and the feedback into a structured data package, where the feedback and classifier unit is configured to process the structured data package as the data object.

Additionally, in accordance with a preferred embodiment of the present invention, the system further includes a classification, feedback, and question (CFQ) editor configured to create the set of predefined ternary questions by generating differentiating questions for each of a plurality of classification categories.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a chatbot system using Retrieval-Augmented Generation (RAG);

FIG. 2 is a schematic illustration of a feedback-driven adaptive Artificial Intelligence (AI) chatbot system, constructed and operative in accordance with the present invention;

FIG. 3 is a schematic illustration of the feedback sub-system of FIG. 2, constructed and operative in accordance with the present invention;

FIG. 4 is a schematic illustration of the sub elements of the chatbot system of FIG. 2, constructed and operative in accordance with the present invention;

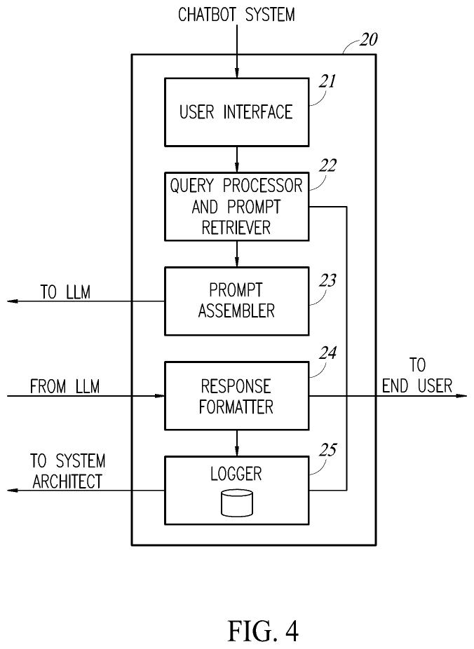

FIG. 5 is an example of a template prompt for creating yes/no/do not know questions for the system of FIG. 2, constructed and operative in accordance with the present invention;

FIG. 6 is a schematic illustration of the sub elements of the feedback and classifier unit of FIG. 2, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that conventional RAG systems suffer from significant architectural and computational limitations that prevent them from adapting effectively to user needs and feedback. In the prior art approach to Retrieval-Augmented Generation (RAG), the knowledge base is static and does not update based on feedback from responses. This static architecture fails to solve the inherent technical problem of creating a self-improving, computationally efficient feedback loop, requiring resource-intensive manual updates or complete system retraining to incorporate new information. Feedback is typically the information provided by the system owner regarding the performance of the AI chatbot, which can be used to improve the system's responses and functionality. Additionally, the prompts are also typically static, with only the user context changing while the system prompt instructions remain the same, resulting in an architecturally rigid system incapable of dynamic behavioral adaptation.

Applicant has further realized that traditional LLM-based chatbots have limitations in adapting based on user feedback. While they can update their knowledge bases, refining their behavior from interactions is a long and hard process. Currently, LLM-based chatbots employ one of two primary technologies for learning new information: fine-tuning or Retrieval-Augmented Generation (RAG). Incorporating a feedback loop in a fine-tuned model is time-consuming, while the static nature of RAG fails to create an evolving user experience. Furthermore, the effectiveness of LLMs in classification tasks is limited, and tasking a single LLM with both response generation and direct feedback classification creates a processing bottleneck. This dual-purpose use leads to unpredictable computational behavior, as the model must expend significant resources on a complex classification task for which it is not optimized. Comprehensive class definitions are often a prerequisite for accurate performance, and LLMs tend to exhibit overconfidence in their predictions, which is not necessarily justified. Due to their complexity, LLMs are difficult to understand, posing transparency and trust challenges.

Applicant has realized that the above mentioned limitations may be overcome by a feedback-driven, adaptive AI chatbot system capable of continuous learning and improvement. The system introduces a dynamic feedback loop where a query, the chatbot's response, and the owner's feedback is processed to dynamically update both the system's knowledge and its core operational instructions (prompts). Unlike static prior art systems or systems that rely on a single, monolithic LLM for all processing tasks, the inventive system classifies the feedback and generates new documents that are integrated into its databases. This specific, ordered combination of processing steps improves the functioning of the computer system itself by creating a more efficient and reliable data processing pipeline, resulting in reduced latency and improved system predictability. These generated documents can either be knowledge documents, which add to or correct the contextual information provided to the LLM, or prompt instruction documents, which modify the chatbot's underlying system prompts to adapt its behavior, tone, or conversational boundaries.

Furthermore, to overcome the unreliability of direct feedback classification by an LLM, Applicant has also realized that correct classification is imperative to processing user feedback. Instead of tasking the LLM with direct classification, the system may use the LLM as a feature builder that can process feedback by answering a series of predefined, differentiating ternary (yes/no/do not know) questions about the feedback. The resulting vector of yes/no/do not know answers provides a structured set of features that is then fed into a more robust and interpretable machine learning model, such as a decision tree classifier. This two-stage approach reliably determines the correct class for the feedback, ensuring the system can accurately distinguish between feedback intended to enrich its knowledge and feedback intended to modify its behavior, thereby enabling a truly adaptive and evolving conversational AI.

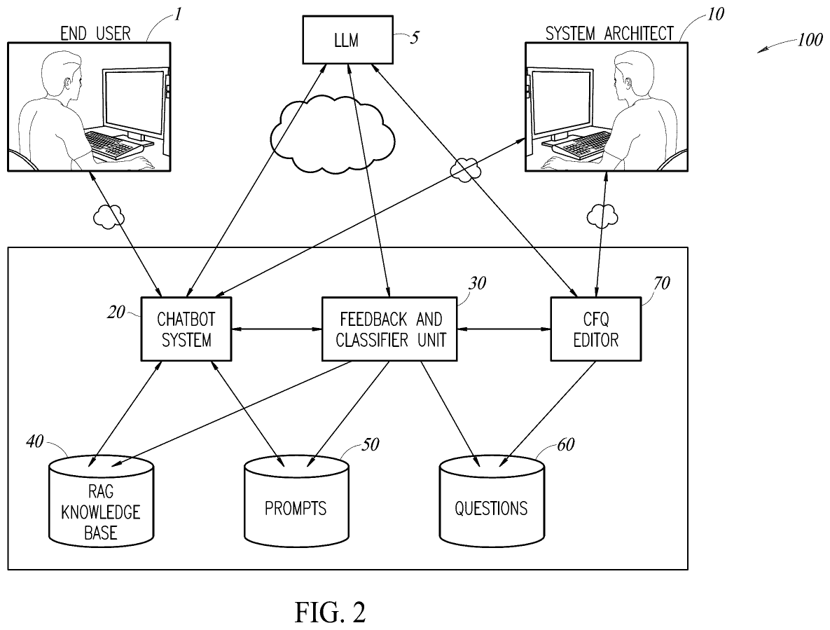

Reference is now made to FIG. 2, which illustrates a schematic diagram of a feedback-driven adaptive AI chatbot system 100, constructed and operative in accordance with a preferred embodiment of the invention. System 100 may further comprise a chatbot system (chatbot) 20, a feedback and classifier unit 30, a RAG knowledge base 40, a prompts database 50, a questions database 60 and a classification, feedback, and question (CFQ) editor 70. System 100 may be in communication with LLM 5. In an alternative embodiment, LLM 5 may be integrated within the system 100 hardware or may be integrated into the end-user 1's client machine (using software and/or hardware).

It will be appreciated that system 100 may be implemented within large platform environments, such as Website Building Systems (WBSs), to provide comprehensive conversational AI capabilities across multiple organizational levels. In such multi-tenant implementations, system 100 may support hierarchical user structures where system architects at higher organizational levels create and manage chat-based assistants for users at lower levels.

For example, in a blog platform implementation, system 100 may support multiple user tiers including platform administrators, blog owners, and blog readers. Higher-level users may utilize CFQ editor 70 and other administrative components to create and configure chatbots for lower-level users, providing domain-specific assistance for blog creation, content management, and reader interaction.

The multi-tenant architecture may include tenant isolation mechanisms to ensure that knowledge bases, prompt databases, and classification systems remain appropriately segregated between different organizational units while allowing for shared infrastructure and common processing capabilities.

It will be appreciated that LLM 5 may be chosen and evaluated for its ability for domain adaptation. While open LLM benchmarks can estimate general-purpose capabilities, the selection of LLM 5 may be based on custom benchmarks designed to assess its knowledge of a specific domain and its performance on domain-specific tasks. The goal of fine-tuning with domain-specific training data is to increase the LLM's knowledge around this particular domain. Therefore, LLM 5 should be a model that has been evaluated for domain adaptation with common training approaches, such as domain adaptive pre-training (DAPT) and supervised fine-tuning (SFT). An example of a suitable LLM may be licensed from Llama (commercially available from Meta Platforms Inc.). Proprietary LLMs are not typically valid candidates as their training methods are not accessible, making them not readily trainable. Furthermore, a model that performs well on custom benchmarks may indicate that it already possesses some domain information, potentially reducing the need for extensive domain-specific token training.

It will be appreciated that the training data for LLM 5 is a core element in achieving domain-specific performance. While many domains may have knowledge already included in a pre-trained LLM, fine-tuning with extensive, high-quality data can significantly increase the knowledge around a specific domain. The design of training datasets may involve considering the sampling between different data sources as a key hyperparameter. To maintain the LLM's performance on common knowledge, the training process may also include training on public data. In some embodiments, domain-specific reading comprehension texts may be used to improve the model's performance. A key consideration in this process is that the LLM can learn everything from the data, including undesirable information, which necessitates careful data preparation and curation.

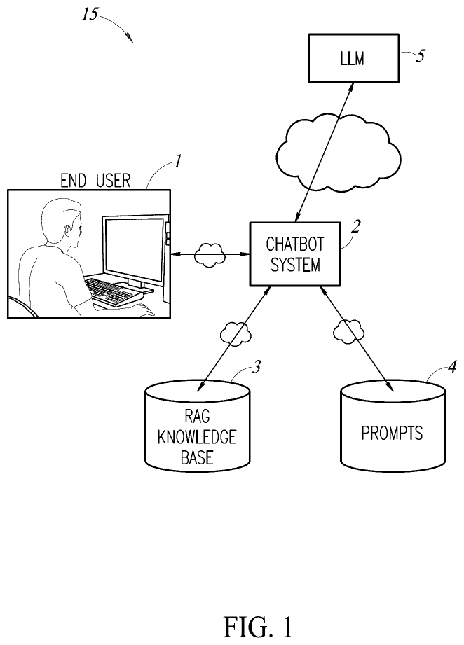

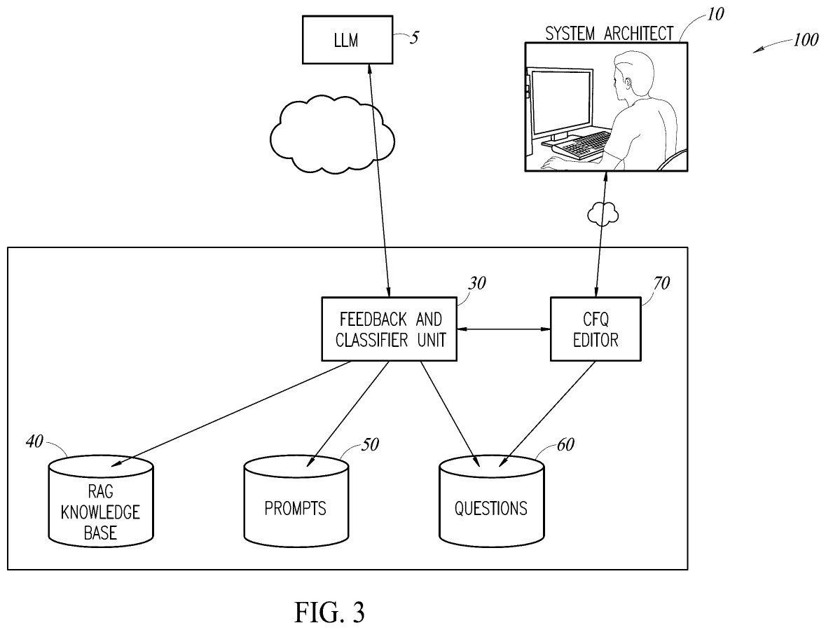

It will also be appreciated that system 100 is designed to facilitate two primary interaction flows. The first is a standard interaction flow where an end-user communicates with chatbot 20 providing a query and generating a response as shown in (FIGS. 1 and 2). The second is a feedback and learning flow where a system architect 10 provides feedback on the performance of chatbot 20 and feedback and classifier unit 30 processes the feedback (together with the original query and LLM response) to dynamically update the system 100's knowledge base and operational prompts as shown in FIG. 3 to which reference is now made, thereby creating a continuously improving and adaptive system.

It will be further appreciated that system 100 may continuously update knowledge base 40 based on user interactions and feedback ensuring that chatbot 20 remains current with the latest information, improving the relevance and accuracy of responses over time. It may also dynamically modify prompts based on retrieved “prompt instruction documents,” allowing it to tailor system instructions to specific contexts or user needs. This may lead to more precise and contextually appropriate responses, enhancing the versatility and adaptability chatbot 20.

Furthermore, by integrating feedback to refine the knowledge base and prompts, system 100 may continuously learn and improve its performance without requiring manual updates or retraining which leads to improved relevance and accuracy of future responses.

System 100 may also allow for customization to specific domains of knowledge, making it suitable for a wide range of applications such as business operations, technical support, customer service, and product information and its architecture is designed to handle the growing amount of data and complexity of queries, ensuring scalability and long-term viability.

By automating the feedback loop and document generation, system 100 may reduce the time and resources typically spent on manual updates and training of chatbot 20.

It will be appreciated that an end-user 1 may be defined as a user of the pertinent system for which a chatbot has been provided. A system architect 10 may be defined as the individual or entity responsible for the initial setup, ongoing configuration, and refinement of chatbot system 20. In an embodiment in which system 100 is integrated with a WBS, an e-shop or an e-com platform, system architect 10 may be the website (or e-shop) owner or operator.

It will also be appreciated that system architect 10 may be other forms of feedback providers who control the environment of chatbot system 20. In an alternative embodiment, similar to end-user 1, system architect 10 may also be an AI agent.

Chatbot system 20 may handle interactions with end user 1 from the initial query to delivering a final formatted response. Reference is now made to FIG. 3 which illustrates the elements of chatbot system 20. Chatbot system 20 may comprise a user interface 21, a query processor and retriever 22, a prompt assembler 23, a response formatter 24 and a logger 25.

User interface 21 may provide the means for end-user 1 to input a query and to display the generated response.

Query processor and retriever 22 may receive the raw query from user interface 21 and process the query into a suitable format for searching and may retrieve relevant contextual documents from RAG knowledge base 40 and relevant prompt instruction documents from prompts database 50. Upon receiving the end user 1's query, its first action may be to convert the textual query into a numeric vector representation, also known as an embedding. This vector mathematically captures the semantic meaning of the query. This query vector is then used to perform a vector retrieval process, which involves a high-speed similarity search against the vector indexes stored in RAG knowledge base 40 and prompts database 50 whose own vector representations are most semantically similar, or “closest” in vector space, to the query vector.

It will be appreciated that the RAG knowledge base 40 and prompts database 50 may be implemented using a vector database, which is a specialized storage system designed to maintain and efficiently index the numeric vector representations of documents to enable fast and scalable retrieval based on vector similarity. Any database system that provides the functionality for storing, indexing, and performing similarity searches on vector embeddings may be utilized. This similarity is a mathematical measure of the conceptual closeness between the query vector and the document vectors. The “high-speed similarity search” may be performed using one of a variety of mathematical functions to calculate this closeness, such as, but not limited to, cosine similarity, dot-product, or Euclidean distance. The documents with the highest similarity scores, indicating they are the “closest” in vector space, are then retrieved as the top-scoring documents.

It will be further appreciated that this vector retrieval process may be part of a hybrid ranking system used to identify the top-scoring documents. Such a system may combine the semantic scoring derived from the vector similarity search with lexical or text-based scoring, which evaluates how well documents match the query based on specific keywords or textual structure. By employing a hybrid ranking approach, query processor and retriever 22 may identify top-scoring documents based on a more comprehensive measure of relevance that considers both conceptual similarity and textual accuracy. In embodiments where multiple documents are determined to have high or equivalent relevance scores through this process, all such documents may be retrieved. The top-scoring contextual and instructional documents are then retrieved.

Prompt assembler 23 may implement a sophisticated template-based system for dynamic prompt modification. The base prompt templates may include predefined variable slots, such as “${boundaries}” or “${tone_instructions}”, that serve as insertion points for dynamic content retrieved from prompt instruction documents.

When query processor and retriever retrieve prompt instruction documents 22, prompt assembler 23 may parse these documents to identify the appropriate template integration points and instruction content. System 100 may support multiple modification approaches, including additive modifications that append text to existing prompts, template-based modifications that insert content into predefined slots, and transformation-based modifications that may use specialized processing logic to combine prompts with adaptation instructions. In an alternative embodiment, prompt assembler 23 may utilize an AI model to combine prompts and adaptation instructions.

Thus, prompt assembler 23 may receive the original query and the prompt instruction documents retrieved by query processor and retriever 22 and may construct the final, comprehensive prompt to be sent to LLM 5, combining the user's query with the retrieved knowledge for context and the retrieved instructions for dynamic behavioral adaptation. An example prompt could be “You are an AI assistant that acts as this site owner and offers a specific range of information based only on the given content. When you answer, you speak like the site owner. ${boundaries}.”

Response formatter 24 may receive the raw output from LLM 5 and process it into a clean, user-friendly format before sending it to user interface 21 for display to end-user 1.

Logger 25 may store queries and associated responses for later review by system architect 10.

As discussed herein above, system architect 10 may review the query and generated response provided by LLM 5 and provide feedback. It will be appreciated that conversations may not be monitored in real time and that system architect 10 may review queries and associated responses as stored by logger 25 in his own time. It will be further appreciated if corrective feedback is provided, documents stored by RAG knowledge base 40 and prompts database 50 may require updating to prevent further contradictions as discussed in more detail herein below.

System architect 10, using their expert domain or case specific knowledge (e.g., as the owner of the business that chatbot 20 represents) may evaluate the quality and accuracy of chatbot 20's response. It will be appreciated that they are looking for several potential issues such as factual inaccuracy (chatbot 20 provided incorrect information), incompleteness (the answer was technically correct but lacked important details and contained hallucination) and whether LLM 5 invented information that is not true (e.g., a non-existent discount). System architect 10 may also look for behavioral errors such as chatbot 20 answered a question which should have deflected or refused to answer or used an incorrect tone or style and therefore the response did not match the desired brand voice.

Once system architect 10 has identified a deficiency in the response provided by chatbot 20, he may provide feedback. It will be appreciated that feedback may be provided as simple, natural language text using CFQ editor 70. As discussed herein above, system architect 10 may also be an AI agent. It will be appreciated that in this embodiment, system 100 may be automated so that the AI agent provides feedback on demand or some form of alert that the response provided to the query is incorrect.

An example feedback could be feedback for knowledge enrichment to correct or add detail to factual knowledge provided by chatbot 20. For example, end-user 1 may ask “When are you open?” and receive a response “We are open every day.” System architect 10 may recognize that this answer is too vague and unhelpful. He may correct the answer to “We are open every weekday from 9 am to 4 pm, and weekends from 10 am to 6 pm”.

In this scenario, system architect 10's feedback may provide correct and complete information. Feedback and classifier unit 30 may classify this feedback as an “enrichment” and generate a knowledge document to update its knowledge base as discussed in more detail herein below.

Another example of feedback is behavioral feedback. This type of feedback is given to instruct chatbot 20 how to behave, setting rules and boundaries.

For example, end-user 1 may ask “Are there discounts?”. Chatbot 20 may respond “Yes we have a 100% discount on all products”. In this scenario, system architect 10 may identify this as a dangerous hallucination and decide that chatbot 20 should not discuss discounts at all. Therefore, the feedback provided is “don't answer about discounts”. This feedback may be classified as “mute” i.e., do not answer.

As discussed herein above, system 100 not only provides feedback from system architect 10 but also classifies it to determine its purpose. The end result is either a knowledge document to update RAG knowledge base 40 in order to enrich content for chatbot 20 or a prompt instruction document to update prompts database 50 to update how chatbot 20 behaves i.e., the modification of prompts to modify chatbot 20's operational instructions, rules, or persona.

For the discount example above, the feedback may not provide factual information to enrich content but rather a behavioral rule. For the example prompt of:

“You are an AI assistant that acts as this site owner and offers a specific range of information based only on the given content. When you answer, you speak like the site owner. ${boundaries},” may be updated so that the variable ${boundaries} is changed with “Don't answer about discounts.”

Therefore, in future interactions, when a query about discounts is detected, this prompt instruction document is retrieved and used to dynamically modify chatbot 20's core instructions, causing it to avoid answering the question.

Once the feedback is submitted, feedback and classifier unit 30 may takeover, initiating the automated process of classification and knowledge/prompt generation.

It will be appreciated that a novel aspect of the invention is the 2-stage classification flow used by feedback and classifier unit 30 to ensure a reliable determination of the feedback's purpose. This process avoids the inconsistencies of direct classification by a large language model (LLM). In the first stage, LLM question processor 32 utilizes an LLM not as a classifier, but as a feature extractor. It processes an unstructured {query, response, feedback} data object by answering a series of predefined, differentiating ternary (yes/no/do not know) questions retrieved from questions database 60. The answers to these questions may be compiled into a structured ternary feature vector. In the second stage, this feature vector is passed to a decision tree classifier 33. Decision tree classifier 33, having been pre-trained on such vectors, may follow its logic path based on the yes/no/do not know answers to output a single, definitive classification label.

As discussed herein above, as part of the setup process of system 100, system architect 10 may pre-categorize classes for any feedback given in relation to its query and response via CFQ editor 70. Example classes may be but not limited to:
Enrichment: this class is used when feedback either adds to or corrects the response.
Escalate: this class is employed when the conversation requires the involvement of the site owner.
Mute: this class is selected when the owner prefers that the system does not respond to certain queries.
Technical issue: this class addresses scenarios where there is a technical problem within the workflow.
Navigate: this class is used when the conversation needs to be redirected to a specific area.
Tone Style: this class is applied when there is feedback regarding the tone or style of the chat's interactions.
Insufficient data: when there is information lacking.
Nothing: this class is chosen when no action is required.

It will be appreciated that system architect primarily generates the initial training data 10, which may also be augmented using LLM 5. System architect 10 may create representative examples for each classification category. For example (in JSON):
“input”: {
“query”: “When are you open?”,
“response”: “We are open every day”,
“feedback”: “We are open weekdays 9 am-4 pm, weekends 10 am-6 pm”
},
“ground_truth_label”: “enrichment”,

It will be appreciated that LLM 5 may also be given the classifications and instructed to classify any feedback accordingly, but Applicant has realized that LLM's in general may require an extensive understanding of class definition to perform accurately, that LLMs tend to exhibit overconfidence in their predictions and may confidently choose a wrong class and due to their complexity may struggle to define the boundaries between multiple classes in a single prompt leading to inconsistent results.

CFQ Editor 70 may also be used by system architect 10 to develop a series of ternary yes/no/do not know questions (either manually or with the help of LLM 5) about the given data to be stored in questions database 60. It will be appreciated that system architect 10 may manually add or modify questions which are stored in questions database 60 to improve classification accuracy and may also test questions on sample inputs to evaluate the effectiveness in classifying different types of feedback. Based on the test results, system architect 10 may iterate the questions set refining, adding, or removing questions as needed.

CFQ editor 70 may facilitate a comprehensive question development process for optimizing classification accuracy. The question generation process may begin with an automated phase where LLM 5 is provided with complete descriptions of all classification categories and instructed to generate differentiating questions for each class or combination of classes.

Following the automated generation phase, system architect 10 may engage in manual refinement activities through CFQ editor 70. This manual process may include adding questions that improve class separation, removing questions that fail to provide meaningful differentiation between categories, and modifying question phrasing to enhance clarity and consistency.

CFQ editor 70 may provide testing capabilities that allow system architect 10 to evaluate question effectiveness using sample input data. Based on test results showing classification accuracy and consistency, the question set may be iteratively refined through multiple cycles of testing, analysis, and modification until optimal performance is achieved.

Therefore, instead of providing a direct classification prompt to LLM 5, and entrusting LLM 5 to perform the classification, yes/no/do not know questions may be used as an input vector representing query, response, and feedback to guide correct classification according to the correct class. It will be appreciated that a key strength of LLMs is their capability to respond well to ternary questions.

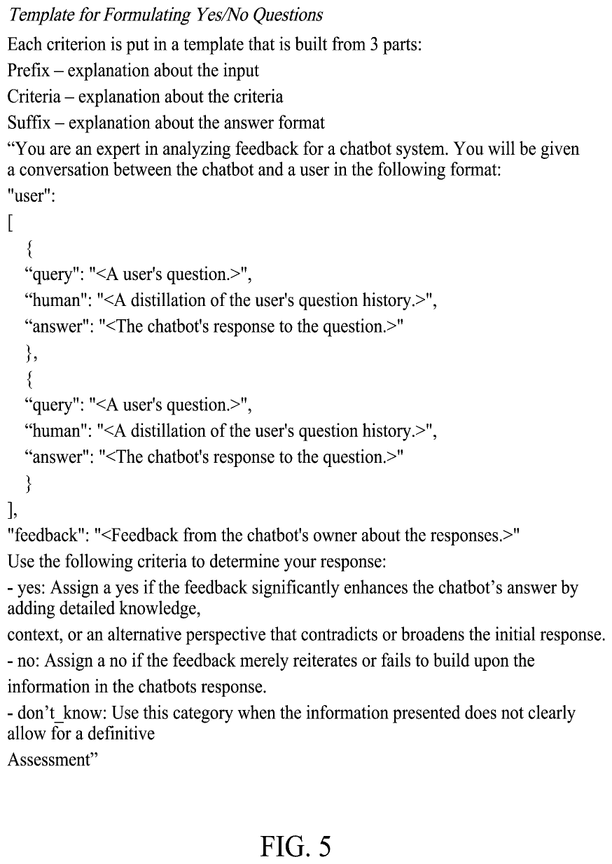

Reference is made to FIG. 5 which illustrates a template or prompt that can be used for formulating yes/no/do not know questions with the help of LLM 5. It will be appreciated that the questions may appear in the following format:
a. Prefix:
   i. LLM rule assignment
   ii. Explanation about the format of the input
b. Criterion:
   i. Question about the criterion.
   ii. Yes—Elaboration about the meaning of yes.
   iii. No—Elaboration about the meaning of no
   iv. Do not Know—Elaboration about the meaning of not knowing.
c. Suffix:
   i. Repeating the question
   ii. Criterion reasoning
   iii. Criterion answer (Yes/No/Do not Know)

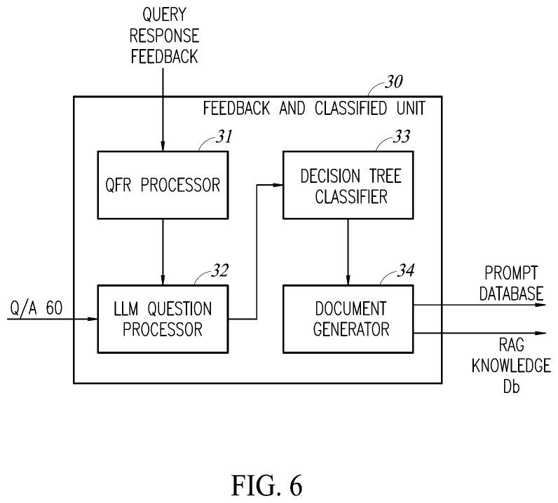

Reference is now made to FIG. 6 which shows the sub elements of feedback and classifier unit 30. Feedback and classifier unit 30 may comprise a query, response, and feedback (QRF) processor 31, an LLM question processor 32, a decision tree classifier 33 and a document generator 34.

QRF processor 31 may function as the initial data-staging component. Its function is to gather and structure the complete context of a conversation that is under review. It receives three distinct pieces of raw textual data, the original query, the response generated by chatbot 20 and the feedback from system architect 10 and consolidates them into a single structured data package to provide a unified data object (such as structured JSON) to LLM question processor 32 containing the {query, response, feedback} input.

LLM question processor 32 may retrieve the list of yes/no/do not know questions from questions database 60 and apply them to the {query, response, feedback} input. It may run them through LLM 5 in order to receive a vector of yes/no/do not know answers. For example:
Question 1: “Does the feedback correct the answer given by the AI?”
LLM 5 answers: No.
Question 2: “Does the feedback contain an instruction?”
LLM 5 answers: Yes.
Question 3: “Is the feedback related to the tone or style of the chat's interactions?”
LLM 5 answers: Yes.
Question 4: “Does the feedback provide additional knowledge not present in the chatbot's response?”
LLM 5 answers: do not know.

LLM question processor 32 may then collate these answers into a feature vector: [No, Yes, Yes, Do not know].

This simple, structured vector is then passed to decision tree classifier 33. Decision tree classifier 33, having been trained on such vectors, may follow its logic path (Is Q2 Yes?->Is Q3 Yes?->Classify as “Tone Style”) and output the final, reliable classification.

Decision tree classifier 33 may use a decision tree, a pre-trained machine learning model such as CatBoost available from https://catboost.ai/to analyze the pattern of yes/no/don't know answers in the feature vector. By following the branches of the tree based on the answers, it may arrive at a final, definitive conclusion about the intent of the feedback.

The machine learning model used by decision tree classifier 33 may be a gradient boosting algorithm particularly well-suited for categorical features which can handle categorical/ternary features natively. The training process may analyze patterns in the feature vectors and use decisions rules. For example, training data may be:
Feature Vector: [No, Yes, Yes, No]→Label: “tone_style”
Feature Vector: [Yes, No, No, Yes]→Label: “enrichment”
Feature Vector: [No, Yes, No, No]→Label: “mute”

In this manner, multiple decision trees may be built and combined for robust predictions. The trained model may also be validated before use on a known validation set to ensure it generalizes well to unseen data. As system 100 operates, new {query, response, feedback} examples are collected along with their classifications. These are also used for training.

Periodically, the model may be retrained with expanded datasets that include original training examples, new production examples that were correctly classified and edge cases or misclassifications that were manually corrected.

Decision tree classifier 33 may then output a single, specific classification label for the feedback, such as “enrichment” for the above mentioned example or “mute,” “tone style,” “escalate” etc.

It will be appreciated that a decision tree is a hierarchical structure consisting of nodes and branches. Each internal node in the tree represents one of the specific yes/no/do not know questions from questions database 60 (e.g., “Does the feedback contain an instruction?”).

Each branch extending from a node may represent an answer to that question (“Yes”, “No” or “Don't Know”).

The terminal nodes at the end of each path may represent the final classification label.

When decision tree classifier 33 receives the input vector, it traverses the tree from the top (the root node) down to a leaf node. At each node, it looks at the corresponding answer in the input vector and the appropriate “Yes” or “No” branch to the next node. This process continues until it reaches a leaf node, and the label of that leaf node becomes the final output.

Document generator 34 may function as a translator and assembler, converting the abstract classification decision output by decision tree classifier 33 into a concrete, structured, and machine-readable document that system 100 can use to learn and adapt. It is the component that effectively “closes the loop” between human feedback and system evolution.

Document generator 34 may receive the decision output i.e. single, unambiguous class label (e.g., “enrichment”, “mute”, “tone style” etc.) provided by decision tree classifier 33 which dictates the type of document that needs to be created together with the {query, response, feedback} triplet originally processed by QRF processor 31. Document generator 34 may use a versioned document approach and therefore may create the pertinent document accordingly. The pertinent document may be one of a plurality of types, including a knowledge document, a prompt instruction document, or a flow control document, which is then used to (update RAG knowledge base 40 and prompts database 50 accordingly for future retrieval.

It will be appreciated that documents supported by system 100 are structured data objects rather than simple text files, designed to enable dynamic retrieval and application. The knowledge documents may comprise:
Content field: contains the factual information or corrected knowledge to be provided as context to the LLM;
“Document type: marked as “knowledge” to indicate it should be used for contextual enrichment;
Metadata: includes creation timestamp, source feedback, and relevance scoring information. his relevance scoring information may comprise a priority weight, where a higher weight is automatically assigned to knowledge documents generated from feedback intended to correct a factual error (for example). This ensures that corrected information is prioritized by query processor and retriever 22 during subsequent similarity searches, effectively superseding any older, contradictory information that may exist in knowledge base 40.
Vector embedding: mathematical representation for semantic similarity matching during retrieval.

The prompt instruction documents may have a more complex structure to enable dynamic integration into system prompts:
Instruction type: specifies how the instruction should be applied (e.g., “boundary”, “tone”, “behavior”);
Template integration point: identifies where in the prompt template the instruction should be inserted;
Instruction content: the specific text or rule to be dynamically inserted;
Priority level: determines precedence when multiple instructions apply. Document generator 34 may be configured to assign a higher priority level to newly generated prompt instruction documents, particularly when the classification label from the decision tree classifier 33 indicates the feedback is intended to correct undesirable or harmful chatbot behavior (for example). This ensures that the most recent and specific behavioral rules govern the chatbot's responses when multiple, potentially conflicting, instructions are retrieved for the same query context;
Conditional logic: optional conditions for when the instruction should be activated. It will be appreciated that the logic may be in the form of JS snippets (or other forms of interpreted or executable code).

It will be appreciated that in addition to knowledge and prompt instruction documents, document generator 34 may be configured to create a flow control document. This type of document is generated when the classification label indicates a need to manage the conversational workflow itself, rather than providing new content or modifying the chatbot's persona. For example, a classification label of “escalate” may trigger the creation of a flow control document. Such documents are designed to be retrieved by query processor and retriever 22 but are intercepted by the system before reaching the prompt assembler 23, allowing them to redirect or terminate the standard processing pipeline.

It will be further appreciated that the document generation process may further comprise a contradiction detection and resolution step to ensure the integrity of knowledge base 40 and prompts database 50. Before a new document is finalized and inserted, particularly a knowledge document resulting from corrective feedback, document generator 34 may perform a contradiction check.

Document generator 34 may implement a sophisticated priority weighting system to ensure information accuracy and consistency. When generating knowledge documents from feedback intended to correct factual errors, document generator 34 may automatically assign higher priority weights to these corrective documents. This priority weighting may influence the retrieval process, causing query processor and retriever 22 to prioritize corrected information during subsequent similarity searches, effectively superseding older, potentially contradictory information that may exist in knowledge base 40.

The contradiction detection process may be implemented as a multi-stage verification system. Before finalizing any new document, particularly knowledge documents resulting from corrective feedback, document generator 34 may perform a comprehensive semantic similarity search to identify existing documents with high cosine similarity scores relative to the new content. When highly similar existing documents are identified, document generator 34 may perform a content comparison analysis to detect factual or instructional inconsistencies.

Upon detecting such a contradiction, document generator 34 may flag the conflict and transmit a warning notification to CFQ editor 70 which may provide a warning to system architect 10, for example, through a suitable interface in CFQ editor 70. The notification may present both the existing and the proposed new document, requiring the system architect to manually review the conflict and approve, reject, or modify the new document.

Thus, the document generation process may include creating the document structure, generating embedding via API and a semantic similarity check to find existing documents with cosine similarity followed by insertion into the pertinent database by updating the associated vector index with the new embedding and log creation of metadata.

Thus, system 100 represents a feedback-driven, adaptive AI chatbot system designed to continuously improve its performance through a novel learning cycle. While system 100 handles standard end-user 1 queries by leveraging an LLM and a Retrieval-Augmented Generation knowledge base, its core innovation lies in how it processes feedback from a system architect. Upon receiving natural language feedback, the system employs a unique classification method to determine the architect's intent, deciding whether the feedback is meant to enrich factual knowledge or modify operational behavior to system 100 to dynamically augment future interactions, either by enriching the information provided to the LLM or by altering the very instructions that govern its responses.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general-purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general purpose computers may comprise at least one communication element to enable communication with a data network and/or a mobile communications network.

An AI agent can be considered a software-implemented computational entity configured to autonomously perceive input data from its environment (including digital, physical, or simulated domains), process the data using one or more machine learning, rule-based, statistical, or symbolic reasoning techniques, and execute goal-directed actions or generate outputs in response to the data.

Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fitted or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

Machine learning models may be trained for different needs and different ML-based engines. Training data may include any gathered information. The ML models may be any suitable model for the task or activity implemented by each ML-based engine. Machine learning models are known in the art and are typically some forms of neural network. The term refers to the ability of systems to recognize patterns based on existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or autoencoders) to generate definitions and elements.

In various embodiments, large language models (LLMs) include transformer-based, state-space, and mixture-of-expert architectures; dense, sparse, and hybrid parameterizations; monomodal and multimodal models processing text, speech, images, video, and 3D data. Technologies encompass instruction tuning, RLHF/RLAIF, retrieval-augmented generation, tool/function calling, program synthesis, verifiable reasoning, and neuro-symbolic integration. Emerging variants support streaming inference, ultra-long context, memory-augmented retrieval, federated and on-device fine-tuning, speculative decoding and quantization for edge deployment, and confidential computing with differential privacy or homomorphic encryption. Additional embodiments employ multi-agent orchestration, autonomous task planning, safety/guardrail layers, world models, and hardware acceleration (GPU/TPU/NPUs, neuromorphic, photonic) for efficient, trustworthy operation.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as: neuro-symbolic systems, neuro-fuzzy systems, hybrid connectionist-symbolic models; fuzzy expert systems; connectionist expert systems, evolutionary neural networks, genetic fuzzy systems, rough fuzzy hybridization, and/or reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction, and reasoning by analogy.

The AI agent may operate continuously or in discrete instances, may learn from historical or real-time inputs, and may update its internal models or policies dynamically. The agent can be embodied in standalone software, embedded systems, distributed cloud environments, or hardware-integrated systems, and may include components such as inference engines, training subsystems, decision-making modules, and interaction interfaces (e.g., via natural language, API, sensors, or actuators).

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In various embodiments, the inventive system can be integrated with various platforms, systems, and applications and other customer-facing systems. Platforms may include website creation platforms, application development platforms, mobile application development platforms, e-commerce platforms (such as those provided by Amazon, eBay, Shopify, and Etsy), social media platforms, and other online presence development, deployment, and hosting systems. The inventive system may also integrate with various heterogeneous computing systems, including: web applications, native mobile apps, desktop software, and browser extensions; enterprise platforms (CRM, ERP, HRIS, collaboration, ticketing) and data stores; vertical solutions (e-commerce, banking, healthcare, education, travel, government); communications channels (website chat, messaging, email, SMS, IVR/telephony, voice assistants, video-conferencing); and device classes (kiosks, ATMs, POS, IoT sensors, smart TVs, wearables, vehicles, AR/VR headsets, game consoles). Deployments may span cloud, edge, and on-premises infrastructures.

The integration can be comprehensive (e.g., systems using the same server or cloud) or using separate servers or clouds. The integration may be achieved via API, SPI, web services, or other methods.

The description above focuses on chat-based interaction between the inventive system and its users. However, such interaction could include interaction via text, voice, combined text and voice, gesture detection, AR/VR interaction, or other methods of interfacing with the user.

While certain features of the invention have been illustrated and described herein, many modifications, substitutions, changes, and equivalents will now occur to those of ordinary skill in the art. It is, therefore, to be understood that the appended claims are intended to cover all such modifications and changes as they fall within the true spirit of the invention.

What is claimed is:

1. A system for dynamically adapting a conversational artificial intelligence (AI) system, the system comprising:
at least one processor; and
a memory storing instructions that, when executed by the at least one processor, configure the system to comprise:
a chatbot system to generate a response to a user query; and
a feedback and classifier unit configured to:
receive said user query, a large language model (LLM) provided response to said query, and system architect provided feedback associated with said response and to create a data object accordingly;
retrieve a set of ternary questions from a questions database;
process, using said LLM, said data object to generate answers to said set of predefined ternary questions, thereby creating a feature vector of ternary answers;
determine, using a decision tree, a classification label for the feedback by processing said feature vector, wherein said classification label indicates whether said feedback relates to a knowledge update or a behavioral instruction update; and
a document generator configured to create a new document based on said classification label and said feedback;
wherein said document generator updates one of a knowledge base or a prompts database with said new document based on said determined classification label.

2. The system of claim 1, wherein said chatbot system comprises:
a query processor and retriever to convert said user query into a vector representation and retrieve relevant documents from said knowledge base and said prompts database based on vector similarity;
a prompt assembler to construct a comprehensive prompt by combining said user query with retrieved knowledge documents and retrieved prompt instruction documents;
a response formatter to process raw output from a large language model into a user-friendly format; and
a logger to store user queries and associated responses.

3. The system of claim 1, wherein said feedback and classifier unit comprises:
a query, response, and feedback (QRF) processor configured to consolidate said user query, said LLM provided response, and said feedback into a structured data package;
an LLM question processor to apply said set of predefined ternary questions to said structured data package using said first machine learning model to generate said feature vector;
a decision tree classifier to traverse a tree structure following a branch corresponding to an answer in said feature vector, wherein a label of said leaf node represents said classification label; and
a knowledge document generator to add to or correct contextual information stored in said knowledge base; or a prompt instruction document configured to modify a behavioral instruction stored in said prompts database.

4. The system of claim 3, wherein said LLM question processor is configured to receive answers of yes, no, or do not know for each of said predefined ternary questions.

5. The system of claim 3, wherein said decision tree is a gradient boosting algorithm trained on feature vectors paired with classification labels.

6. The system of claim 1, wherein said classification label is selected from a group consisting of enrichment, escalate, mute, technical issue, navigate, tone style, insufficient data, and nothing.

7. The system of claim 5, wherein when said classification label indicates enrichment, said document generator creates a knowledge document comprising a content field, a document type marked as knowledge, metadata, and a vector embedding for insertion into said knowledge base.

8. The system of claim 5, wherein when said classification label indicates a behavioral instruction, said document generator creates a prompt instruction document comprising an instruction type, a template integration point, instruction content, a priority level, and conditional logic for insertion into said prompts database.

9. The system of claim 1, further comprising a CFQ editor configured to enable a system architect to provide said feedback and to define said set of predefined ternary questions and to create training data for said decision tree by providing representative examples of feedback paired with ground truth classification labels.

10. The system of claim 1, wherein said system is implemented within a host platform, said host platform being a Website Building System (WBS), wherein said user is one of: a human end-user, first AI agent and a website or e-shop owner or operator; and wherein said system architect provided feedback is received from one of a human system architect or a second AI agent configured to provide said feedback automatically.

11. A computer-implemented method for dynamically adapting a conversational artificial intelligence system, said method comprising:
receiving a user query, an AI-generated response to said user query, and feedback associated with said AI-generated response;
retrieving a set of predefined ternary questions from a questions database;
processing, using a large language model (LLM), said user query, said AI-generated response, and said feedback to generate answers to said set of predefined ternary questions, thereby creating a feature vector of ternary answers;
determining, using a decision tree, a classification label for said feedback by processing said feature vector, wherein said classification label indicates whether said feedback relates to a knowledge update or a behavioral instruction update;
generating a new document based on said classification label and said feedback; and
updating one of a knowledge base or a prompts database with said new document based on said determined classification label.

12. The method according to claim 11, further comprising consolidating said user query, said AI-generated response, and said feedback into a structured data package prior to said processing.

13. The method according to claim 11, wherein said processing to generate answers to said set of predefined ternary questions generates answers selected from yes, no, and do not know.

14. The method according to claim 11, wherein said decision tree is a gradient boosting algorithm trained on feature vectors paired with classification labels.

15. The method according to claim 11, wherein said classification label is selected from a group consisting of enrichment, escalate, mute, technical issue, navigate, tone style, insufficient data, and nothing.

16. The method according to claim 15, wherein when said classification label indicates enrichment, said generating a new document comprises creating a knowledge document comprising a content field, a document type marked as knowledge, metadata, and a vector embedding for insertion into said knowledge base.

17. The method according to claim 15, wherein when said classification label indicates a behavioral instruction, said generating a new document comprises creating a prompt instruction document comprising an instruction type, a template integration point, instruction content, a priority level, and conditional logic for insertion into said prompts database.

18. The method according to claim 11, further comprising converting said user query into a vector representation and retrieving relevant documents from said knowledge base and said prompts database based on vector similarity.

19. The method according to claim 18, further comprising constructing a comprehensive prompt by combining said user query with retrieved knowledge documents and retrieved prompt instruction documents.

20. The method according to claim 11, wherein said receiving feedback comprises receiving feedback from one of a human system architect or an AI agent configured to provide said feedback automatically.
